(19) United States
(12) Patent Application Publication
(10) Pub. No.: US 2003/0186832 A1
(43) Pub. Date: Oct. 2, 2003

(54) Isotropic liquid detergents with improved anti-redeposition

(75) Inventors: Tamara Padron, North Bergen, NJ (US); David A. Binder, Saddle Brook, NJ (US); Nancy C. Diaz, Teaneck, NJ (US); Francoise F. Meyer, Hackensack, NJ (US); Dennis Stephen Murphy, Wyckoff, NJ (US)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/099,516

(22) Filed: Mar. 15, 2002

(51) Int. Cl. C11D 3/37

(52) U.S. Cl. 510/475

(57) ABSTRACT

Isotropic liquid detergents containing a soil release co-polymer and an anti-redeposition enhancer, the latter selected from vinyl pyrrolidone polymer or vinyl pyridine nitrous oxide polymer. The use of soil release co-polymer and the enhancer together leads to a synergistic improvement in soil anti-redeposition. Preferred compositions are colored isotropic compositions packaged in a transparent container.

### FIELD OF THE INVENTION

The present invention relates to isotropic liquid detergents containing specific soil release co-polymer in conjunction with anti-redeposition enhancers selected from vinyl pyrrolidone or vinyl pyridine N-oxide polymers.

### BACKGROUND OF THE INVENTION

The liquid detergent art may be broken down into those detergents in which all components of the liquid system are dissolved into one single liquid phase (e.g., the isotropic liquids); and those which contain sufficient surfactant and/or electrolyte to form a lamellar droplet comprising “onion” type layers dispersed in an electrolyte medium which is capable of suspending undissolved particles in the liquid. These latter liquids are also known as so-called duotropic or structured liquids.

Soil release polymers aid in the removal of soils from fabrics. The polymers interact with the surface of the soil and help remove it from the fabric and help keep it disperse in the wash water. If the soil release polymer is not used, more of the removed soil may be deposited on portions of the fabric causing soiling of previously cleaned fabric. Some soil release polymers may have anti-redeposition properties on certain soil.

Unfortunately, many of the known soil release co-polymer polymers, e.g. polyacrylates, are not soluble in heavy duty liquid detergents and, thus, impact the transparency of the composition and/or cause phase separation. Such results are commercially unacceptable, especially for isotropic liquids, and, particularly so, when isotropic liquids are marketed in transparent/clear containers (so the product is visible through the container).

Falk et al. (U.S. Pat. Nos. 5,723,434 and 5,719,117) teach soil release co-polymers which avoid phase separation and are sufficiently soluble to maintain the isotropic nature of the liquid detergent.

Vinyl pyrrolidone and vinyl pyridine polymers and co-polymers have been used in detergent composition (e.g., as dye transfer inhibiting agents). See U.S. Pat. No. 5,259,994 (Welch et al.), WO 95/07336 (Procter & Gamble), U.S. Pat. No. 5,198,353 (Hawkins et al.), disclosing the use of polyvinyl pyrrolidone for the stabilization of an enzyme dispersion. See also U.S. Pat. No. 4,328,345 (Guilbert), U.S. Pat. No. 5,324,445 (Langley et al.), U.S. Pat. No. 4,242,219 (Borgerman et al.), U.S. Pat. No. 3,254,028 (Wixon et al.) and U.S. Pat. No. 5,234,617 (Hunter et al.), U.S. Pat. No. 4,190,718 (Lorenz et al), U.S. Pat. No. 3,252,995 (Grosser), U.S. Pat. No. 3,689,439 (Field et al.), U.S. Pat. No. 3,235,490 (Goren), U.S. Pat. No. 5,451,341 (White).

### SUMMARY OF THE INVENTION

The present invention relates to isotropic liquid detergents containing specific soil release co-polymers in conjunction with anti-redeposition enhancers selected from vinyl pyrrolidone and/or vinyl pyridine N-oxide polymers, in addition to the surfactant, preferably in a transparent/translucent container.

The present invention is based at least in part on the surprising discovery that the use of certain soil release co-polymers in combination with an anti-redeposition enhancer selected from vinyl pyrrolidone or vinyl pyridine N-oxide polymers attains unexpected improvement in soil anti-redeposition.

### DETAILED DESCRIPTION OF THE INVENTION

Except in the operating and comparative examples, or where otherwise explicitly indicated, all numbers in this description indicating amounts of material or conditions of reaction, physical properties of materials and/or use are to be understood as modified by the word “about.” All amounts are by weight of the liquid detergent composition, unless otherwise specified.

It should be noted that in specifying any range of concentration, any particular upper concentration can be associated with any particular lower concentration.

For the avoidance of doubt the word “comprising” is intended to mean “including” but not necessarily “consisting of” or “composed of.” In other words, the listed steps or options need not be exhaustive.

“Liquid” as used herein means that a continuous phase or predominant part of the composition is liquid and that a composition is flowable at 20° C. (i.e., suspended solids may be included).

Soil Release Co-polymers

The co-polymers suitable for use in the present invention are described in U.S. Pat. Nos. 5,723,434 and 5,719,117 to Falk et al., incorporated by reference herein.

In general, the co-polymer comprises a hydrophilic “backbone” component and a “tail” portion which is a second monomer which is hydrophobic in nature (e.g., akyl methacrylate or styrene).

The hydrophilic backbone generally is a linear, branched or highly cross-linked molecular composition containing one type of relatively hydrophilic monomer unit wherein the monomer is preferably sufficiently soluble to form at least a 1% by weight solution when dissolved in water. The only limitation to the structure of the hydrophilic backbone is that a polymer corresponding to the hydrophilic backbone made from the backbone monomeric constituents is relatively water soluble (solubility in water at ambient temperature and at pH of 3.0 to 12.5 is preferably more than 1 g/l). The hydrophilic backbone is also preferably predominantly linear, e.g., the main chain of backbone constitutes at least 50% by weight, preferably more than 75%, most preferably more than 90% by weight.

The hydrophilic backbone is composed of one monomer unit selected from a variety of units available for polymer preparation and linked by any chemical links including:

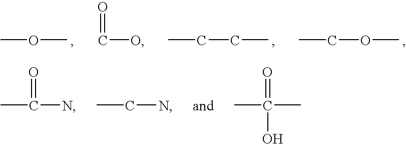

The “tail” group comprises a monomer unit comprising hydrophobic side chains which are incorporated in the “tail” monomer. The co-polymer is made by copolymerizing hydrophobic monomers (tail group comprising hydrophobic groups) and the hydrophilic monomer making up the backbone. The hydrophobic side chains preferably include those which when isolated from their linkage are relatively water insoluble, i.e., preferably less than 1 g/l, more preferred less than 0.5 g/l, most preferred less than 0.1 g/l of the hydrophobic monomers, will dissolve in water at ambient temperature at pH of 3.0 to 12.5. Preferably, the hydrophobic moieties are selected from siloxanes, saturated and unsaturated alkyl chains, e.g., having from 5 to 24 carbons, preferably 6 to 18, most preferred 8 to 16 carbons, and are optionally bonded to hydrophilic backbone via an alkoxylene or polyalkoxylene linkage, for example a polyethoxy, polypropoxy, or butyloxy (or mixtures of the same) linkage having from 1 to 50 alkoxylene groups. Alternatively, the hydrophobic side chain can be composed of relatively hydrophobic alkoxy groups, for example, butylene oxide and/or propylene oxide, in the absence of alkyl or alkenyl groups. Another preferred hydrophobic group includes styrene.

Monomer units which make up the hydrophilic backbone include:

(1) unsaturated, preferably mono-unsaturated, C₁₋₆ acids, ethers, alcohols, aldehydes, ketones or esters such as monomers of acrylic acid, methacrylic acid, maleic acid, vinyl-methyl ether, vinyl sulphonate or vinylalcohol obtained by hydrolysis of vinyl acetate, acrolein;

(2) cyclic units, unsaturated or comprising other groups capable of forming inter-monomer linkages, such as saccharides and glucosides, alkoxy units and maleic anhydride;

(3) glycerol or other saturated polyalcohols.

Monomeric units comprising both the hydrophilic backbone and hydrophobic side chain may be substituted with groups such as amino, amine, amide, sulphonate, sulphate, phosphonate, phosphate, hydroxy, carboxyl and oxide groups.

The hydrophilic backbone is composed of one unit. The backbone may also contain small amounts of relatively hydrophilic units such as those derived from polymers having a solubility of less than 1 g/l in water provided the overall solubility of the polymer meets the requirements discussed above. Examples include polyvinyl acetate or polymethyl methacrylate.

The preferred co-polymers are exemplified by the following structure:

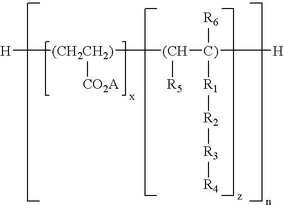

wherein

z is preferably at least 1,

preferably x:z (i.e., hydrophilic backbone to hydrophobic tail) is less than 60, preferably less than 20, more preferably less than 10;

in which the monomer units may be in random order; and

n is at least 1:

R₁ represents —CO—O—, —O—, —O—CO—, —CH₂—, —CO—NH— or is absent;

R₂ represents from 1 to 50 independently selected alkyleneoxy groups preferably ethylene oxide or propylene oxide groups, or is absent, provided that when R₃ is absent and R₄ represents hydrogen or contains no more than 4 carbon atoms, then R₂ must contain an alkyleneoxy group with at least 3 carbon atoms;

R₃ represents a phenylene linkage, or is absent;

R₄ represents hydrogen or a C₁₋₂₄ alkyl or C₂₋₂₄ alkenyl group, with the provisos

a) when R₁ represents —O—CO—, R₂ and R₃ must be absent and R₄ must contain at least 5 carbon atoms;

b) when R₂ is absent, R₄ is not hydrogen and when R₃ is absent, then R₄ must contain at least 5 carbon atoms;

R₅ represents hydrogen or a group of formula —COOA;

R₆ represents hydrogen or C₁₋₄ alkyl; and A is independently selected from hydrogen, alkali metals, alkaline earth metals, ammonium and amine bases and C₁₋₄.

Alternatively, the

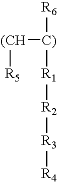

group (defined by z) can be substituted benzene group such as, for example styrene.

The molecular weight of the co-polymer is typically in the range of from 1,000 to 20,000, preferably from 1,500 to 10,000, more preferably from 3,000 to 8,000.

The co-polymer should be used in an amount of from 0.01 to 10% preferably from 0.05% to 5% more preferably from 0.1 to 5%, most preferably from 0.1 to 3%.

Vinyl Pyrrolidone and Vinyl Pyridine Nitrous Oxide Polymers

Vinyl pyrrolidone and vinyl pyridine nitrous oxide “polymers” as used herein includes both homopolymers and co-polymers of vinyl pyrrolidone and vinyl pyridine nitrous oxide (the latter can be polymerized in vinyl pyridine form or in its nitrous oxide form). The term “homopolymers” as used herein means predominantly a homopolymer, although some impurities may be present. In other words, the polymer does not have to be 100% pure to be suitable for use in for the present invention. The vinyl pyrrolidone co-polymers are described in U.S. Pat. Nos. 4,190,718, 3,689,439 and 3,252,995, all incorporated by reference herein. Vinyl pyridine nitrous oxide polymers are described in U.S. Pat. No. 5,451,341, incorporated by reference herein.

Preferably, polyvinyl pyrrolidone (“PVP”) and/or polyvinyl pyridine nitrous oxide are employed, due to their ready commercial availability.

Anti-redeposition enhancer is employed in the present invention in an amount of from 0.01 to 5.0% preferably from 0.05 to 3%, most preferably from 0.05 to 1%, and optimally from 0.1 to 0.5%. The molecular weight of the anti-redeposition enhancer is typically in the range of from 2,000 to 5,000,000, preferably from 5,000 to 100,000, most preferably from 5,000 to 75,000.

In the preferred compositions, the weight ratio of the soil release co-polymer to the anti-redeposition enhancer is in the range of from 20:1 to 1:20, preferably 10:1 to 1:5,more preferably in order to optimize soil anti-redeposition improvement at optimum cost, in the range of from 4:1 to 1:2, optimally from 1:1 to 1:2.

Surfactant

The compositions of the invention contain one or more surface active agents selected from the group consisting of anionic, nonionic, cationic, ampholytic and zwitterionic surfactants or mixtures thereof. The preferred surfactant detergents for use in the present invention are mixtures of anionic and nonionic surfactants although it is to be understood that any surfactant may be used alone or in combination with any other surfactant or surfactants.

Anionic Surfactant Detergents

Anionic surface active agents which may be used in the present invention are those surface active compounds which contain a long chain hydrocarbon hydrophobic group in their molecular structure and a hydrophile group, i.e. water solubilizing group such as carboxylate, sulfonate or sulfate group or their corresponding acid form. The anionic surface active agents include the alkali metal (e.g. sodium and potassium) water soluble higher alkyl aryl sulfonates, alkyl sulfonates, alkyl sulfates and the alkyl poly ether sulfates. They may also include fatty acid or fatty acid soaps. One of the preferred groups of anionic surface active agents are the alkali metal, ammonium or alkanolamine salts of higher alkyl aryl sulfonates and alkali metal, ammonium or alkanolamine salts of higher alkyl sulfates. Preferred higher alkyl sulfates are those in which the alkyl groups contain 8 to 26 carbon atoms, preferably 12 to 22 carbon atoms and more preferably 14 to 18 carbon atoms. The alkyl group in the alkyl aryl sulfonate preferably contains 8 to 16 carbon atoms and more preferably 10 to 15 carbon atoms. A particularly preferred alkyl aryl sulfonate is the sodium potassium or ethanolamine C₁₀ to C₁₆ benzene sulfonate, e.g. sodium linear dodecyl benzene sulfonate. The primary and secondary alkyl sulfates can be made by reacting long chain alpha-olefins with sulfites or bisulfites, e.g. sodium bisulfite. The alkyl sulfonates can also be made by reacting long chain normal paraffin hydrocarbons with sulfur dioxide and oxygen as describe in U.S. Pat. Nos. 2,503,280, 2,507,088, 3,372,188 and 3,260,741 to obtain normal or secondary higher alkyl sulfates suitable for use as surfactant detergents.

The alkyl substituent is preferably linear, i.e. normal alkyl, however, branched chain alkyl sulfonates can be employed, although they are not as good with respect to biodegradability. The alkane, i.e. alkyl, substituent may be terminally sulfonated or may be joined, for example, to the 2-carbon atom of the chain, i.e. may be a secondary sulfonate. It is understood in the art that the substituent may be joined to any carbon on the alkyl chain. The higher alkyl sulfonates can be used as the alkali metal salts, such as sodium and potassium. The preferred salts are the sodium salts. The preferred alkyl sulfonates are the C₁₀ to C ₁₈ primary normal alkyl sodium and potassium sulfonates, with the C₁₀ to C₁₅ primary normal alkyl sulfonate salt being more preferred.

Mixtures of higher alkyl benzene sulfonates and higher alkyl sulfates can be used as well as mixtures of higher alkyl benzene sulfonates and higher alkyl polyether sulfates.

The alkali metal or ethanolamine alkyl aryl sulfonate can be used in an amount of 0 to 70%, preferably 5 to 50% and more preferably 5 to 15% by weight.

The alkali metal or ethanolamine sulfate can be used in admixture with the alkylbenzene sulfonate in an amount of 0 to 70%, preferably 5 to 50% by weight.

Also normal alkyl and branched chain alkyl sulfates (e.g., primary alkyl sulfates) may be used as the anionic component.

The higher alkyl polyethoxy sulfates used in accordance with the present invention can be normal or branched chain alkyl and contain lower alkoxy groups which can contain two or three carbon atoms. The normal higher alkyl polyether sulfates are preferred in that they have a higher degree of biodegradability than the branched chain alkyl and the lower poly alkoxy groups are preferably ethoxy groups.

The preferred higher alkyl polyethoxy sulfates used in accordance with the present invention are represented by the formula:

R¹—O(CH₂CH₂O)ₚ—SO₃M,

where R¹ is C₈ to C₂₀ alkyl, preferably C₁₀ to C₁₈ and more preferably C₁₂ to C₁₅; p is 2 to 8, preferably 2 to 6, and more preferably 2 to 4; and M is an alkali metal, such as sodium and potassium, or an ammonium cation. The sodium and potassium salts are preferred.

A preferred higher alkyl poly ethoxylated sulfate is the sodium salt of a triethoxy C₁₂ to C₁₅ alcohol sulfate having the formula:

C₁₂₋₁₅—O—(CH₂CH₂O)₃—SO₃Na

Examples of suitable alkyl ethoxy sulfates that can be used in accordance with the present invention are C₁₂₋₁₅ normal or primary alkyl triethoxy sulfate, sodium salt; n-decyl diethoxy sulfate, sodium salt; C₁₂ primary alkyl diethoxy sulfate, ammonium salt; C₁₂ primary alkyl triethoxy sulfate, sodium salt; C₁₅ primary alkyl tetraethoxy sulfate, sodium salt; mixed C₁₄₋₁₅ normal primary alkyl mixed tri- and tetraethoxy sulfate, sodium salt; stearyl pentaethoxy sulfate, sodium salt; and mixed C₁₀₋₁₈ normal primary alkyl triethoxy sulfate, potassium salt.

The normal alkyl ethoxy sulfates are readily biodegradable and are preferred. The alkyl poly-lower alkoxy sulfates can be used in mixtures with each other and/or in mixtures with the above discussed higher alkyl benzene, sulfonates, or alkyl sulfates.

The alkali metal higher alkyl poly ethoxy sulfate can be used with the alkylbenzene sulfonate and/or with an alkyl sulfate, in an amount of 0 to 70%, preferably 5 to 50% and more preferably 5 to 20% by weight of entire composition.

Nonionic Surfactant

Nonionic surfactants which can be used with the invention, alone or in combination with other surfactants are described below.

As is well known, the nonionic surfactants are characterized by the presence of a hydrophobic group and an organic hydrophilic group and are typically produced by the condensation of an organic aliphatic or alkyl aromatic hydrophobic compound with ethylene oxide (hydrophilic in nature). Typical suitable nonionic surfactants are those disclosed in U.S. Pat. Nos. 4,316,812 and 3,630,929, incorporated by reference herein.

Usually, the nonionic surfactants are polyalkoxylated lipophiles wherein the desired hydrophile-lipophile balance is obtained from addition of a hydrophilic poly-lower alkoxy group to a lipophilic moiety. A preferred class of nonionic detergent is the alkoxylated alkanols wherein the alkanol is of 9 to 20 carbon atoms and wherein the number of moles of alkylene oxide (of 2 or 3 carbon atoms) is from 3 to 20. Of such materials it is preferred to employ those wherein the alkanol is a fatty alcohol of 9 to 11 or 12 to 15 carbon atoms and which contain from 5 to 8 or 5 to 9 alkoxy groups per mole. Also preferred is paraffin—based alcohol (e.g. nonionics from Huntsman or Sassol).

Exemplary of such compounds are those wherein the alkanol is of 10 to 15 carbon atoms and which contain about 5 to 12 ethylene oxide groups per mole, e.g. Neodol® 25-9 and Neodol® 23-6.5, which products are made by Shell Chemical Company, Inc. The former is a condensation product of a mixture of higher fatty alcohols averaging about 12 to 15 carbon atoms, with about 9 moles of ethylene oxide and the latter is a corresponding mixture wherein the carbon atoms content of the higher fatty alcohol is 12 to 13 and the number of ethylene oxide groups present averages about 6.5. The higher alcohols are primary alkanols. Another subclass of alkoxylated surfactants which can be used contain a precise alkyl chain length rather than an alkyl chain distribution of the alkoxylated surfactants described above. Typically, these are referred to as narrow range alkoxylates. Examples of these include the Neodol-1® series of surfactants manufactured by Shell Chemical Company.

Other useful nonionics are represented by the commercially well known class of nonionics sold under the trademark Plurafac® by BASF. The Plurafacs® are the reaction products of a higher linear alcohol and a mixture of ethylene and propylene oxides, containing a mixed chain of ethylene oxide and propylene oxide, terminated by a hydroxyl group. Examples include C₁₃-C₁₅ fatty alcohol condensed with 6 moles ethylene oxide and 3 moles propylene oxide, C₁₃-C₁₅ fatty alcohol condensed with 7 moles propylene oxide and 4 moles ethylene oxide, C₁₃-C₁₅ fatty alcohol condensed with 5 moles propylene oxide and 10 moles ethylene oxide or mixtures of any of the above.

Another group of liquid nonionics are commercially available from Shell Chemical Company, Inc. under the Dobanol® or Neodol® trademark: Dobanol® 91-5 is an ethoxylated C₉-C₁₁ fatty alcohol with an average of 5 moles ethylene oxide and Dobanol® 25-7 is an ethoxylated C₁₂-C₁₅ fatty alcohol with an average of 7 moles ethylene oxide per mole of fatty alcohol.

In the compositions of this invention, preferred nonionic surfactants include the C₁₂-C₁₅ primary fatty alcohols with relatively narrow contents of ethylene oxide in the range of from about 6 to 9 moles, and the C₉ to C₁₁ fatty alcohols ethoxylated with about 5-6 moles ethylene oxide.

Another class of nonionic surfactants which can be used in accordance with this invention are glycoside surfactants. Glycoside surfactants suitable for use in accordance with the present invention include those of the formula:

RO—R¹O—_{y}(Z)ₓ

wherein R is a monovalent organic radical containing from about 6 to about 30 (preferably from about 8 to about 18) carbon atoms; R¹ is a divalent hydrocarbon radical containing from about 2 to 4 carbons atoms; O is an oxygen atom; y is a number which can have an average value of from 0 to about 12 but which is most preferably zero; Z is a moiety derived from a reducing saccharide containing 5 or 6 carbon atoms; and x is a number having an average value of from 1 to about 10 (preferably from about 1½ to about 10).

A particularly preferred group of glycoside surfactants for use in the practice of this invention includes those of the formula above in which R is a monovalent organic radical (linear or branched) containing from about 6 to about 18 (especially from about 8 to about 18) carbon atoms; y is zero; z is glucose or a moiety derived therefrom; x is a number having an average value of from 1 to about 4 (preferably from about 1½ to 4).

Nonionic surfactants which may be used include polyhydroxy amides as discussed in U.S. Pat. No. 5,312,954 to Letton et al. and aldobionamides such as disclosed in U.S. Pat. No. 5,389,279 to Au et al., both of which are hereby incorporated by reference into the subject application.

Generally, nonionics would comprise 0-50% by wt., preferably 5 to 50%, more preferably 5 to 25% by wt. of the composition.

Mixtures of two or more of the nonionic surfactants can be used.

Cationic Surfactants

Many cationic surfactants are known in the art, and almost any cationic surfactant having at least one long chain alkyl group of about 10 to 24 carbon atoms is suitable in the present invention. Such compounds are described in “Cationic Surfactants”, Jungermann, 1970, incorporated by reference.

Specific cationic surfactants which can be used as surfactants in the subject invention are described in detail in U.S. Pat. No. 4,497,718, hereby incorporated by reference.

As with the nonionic and anionic surfactants, the compositions of the invention may use cationic surfactants alone or in combination with any of the other surfactants known in the art. Of course, the compositions may contain no cationic surfactants at all.

Amphoteric Surfactants

Ampholytic synthetic surfactants can be broadly described as derivatives of aliphatic or aliphatic derivatives of heterocyclic secondary and tertiary amines in which the aliphatic radical may be straight chain or branched and wherein one of the aliphatic substituents contains from about 8 to 18 carbon atoms and at least one contains an anionic water-soluble group, e.g. carboxylate, sulfonate, sulfate. Examples of compounds falling within this definition are sodium 3-(dodecylamino)propionate, sodium 3-(dodecylamino) propane-1-sulfonate, sodium 2-(dodecylamino)ethyl sulfate, sodium 2-(dimethylamino) octadecanoate, disodium 3-(N-carboxymethyldodecylamino)propane 1-sulfonate, disodium octadecyl-imminodiacetate, sodium 1-carboxymethyl-2-undecylimidazole, and sodium N,N-bis (2-hydroxyethyl)-2-sulfato-3-dodecoxypropylamine. Sodium 3-(dodecylamino) propane-1-sulfonate is preferred.

Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. The cationic atom in the quaternary compound can be part of a heterocyclic ring. In all of these compounds there is at least one aliphatic group, straight chain or branched, containing from about 3 to 18 carbon atoms and at least one aliphatic substituent containing an anionic water-solubilizing group, e.g., carboxy, sulfonate, sulfate, phosphate, or phosphonate.

Specific examples of zwitterionic surfactants which may be used are set forth in U.S. Pat. No. 4,062,647, hereby incorporated by reference.

The amount of surfactant used may vary from 1 to 85% by weight, preferably 10 to 50% by weight.

As noted the preferred surfactant systems of the invention are mixtures of anionic and nonionic surfactants.

Particularly preferred systems include, for example, mixtures of linear alkyl aryl sulfonates (LAS) and linear alkoxylated (e.g., ethoxylated) sulfates (AES) with alkoxylated nonionics for example in the ratio of 1:2:1 (i.e., 5:1, preferably 3:1 anionic to nonionic). Preferably, the nonionic should comprise, as a percentage of an anionic/nonionic system, at least 20%, more preferably at least 25%, up to about 75% of the total surfactant system. A particularly preferred surfactant system comprises anionic:nonionic in a ratio of 3: 1.

The compositions of the invention are all unstructured, isotropic compositions.

### Optional Ingredients

Water

The liquid detergent composition of the invention generally includes from 1 to 85% of total (free and bound) water, preferably from 5 to 80%, more preferably from 10 to 70%, most preferably from 20 to 60%, and optimally from 25 to 50%, in order to obtain clarity and ease of the dispersion of the composition during use (% by weight of the composition).

Hydrotropes

In general, addition of hydrotropes helps to incorporate higher levels of surfactants into isotropic liquid detergents than would otherwise be possible due to phase separation of surfactants from the aqueous phase. Hydrotropes also allow a change in the proportions of different types of surfactants, namely anionic, nonionic, cationic and zwitterionic, without encountering the problem of phase separation. Thus, they increase the formulation flexibility. Hydrotropes function through either of the following mechanisms: i) they increase the solubility of the surfactant in the aqueous phase by changing the solvent power of the aqueous phase; short chain alcohols such as ethanol, isopropanol and also glycerol and propylene glycol are examples in this class and ii) they prevent formation of liquid crystalline or lamellar phases of surfactants by disrupting the packing of the hydrocarbon chains of the surfactants in the micelles; alkali metal salts of alkyl aryl sulfonates such as xylene sulfonate, cumene sulfonate and alkyl aryl disulfonates such as DOWFAX® family of hydrotropes marketed by Dow Chemicals are examples in this class.

Other types of suitable hydrotropes include low molecular weight alkyl sulfates (e.g., octylsulfate).

Preferred hydrotropes in the compositions of the present invention are polyols, which may also act as enzyme stabilizers, such as propylene glycol, ethylene glycol, glycerol, sorbitol, mannitol and glucose.

In general, hydrotropes may be present in an amount of about 1% to 25% by wt., preferably 1% to 10% by wt. of the composition.

Builders/Electrolytes

Builders which can be used according to this invention include conventional alkaline detergency builders, inorganic or organic, which should be used at levels from about 0.1% to about 20.0% by weight of the composition, preferably from 1.0% to about 10.0% by weight, more preferably 2% to 5% by weight.

As electrolyte may be used any water-soluble salt. Electrolyte may also be a detergency builder, such as the inorganic builder sodium tripolyphosphate, or it may be a non-functional electrolyte such as sodium sulphate or chloride. Preferably the inorganic builder comprises all or part of the electrolyte. That is the term electrolyte encompasses both builders and salts.

Examples of suitable inorganic alkaline detergency builders which may be used are water-soluble alkalimetal phosphates, polyphosphates, borates, silicates and also carbonates. Specific examples of such salts are sodium and potassium triphosphates, pyrophosphates, orthophosphates, hexametaphosphates, tetraborates, silicates and carbonates.

Examples of suitable organic alkaline detergency builder salts are: (1) water-soluble amino polycarboxylates, e.g., sodium and potassium ethylenediaminetetraacetates, nitrilotriacetatesand N-(2 hydroxyethyl)-nitrilodiacetates; (2) water-soluble salts of phytic acid, e.g., sodium and potassium phytates (see U.S. Pat. No. 2,379,942); (3) water-soluble polyphosphonates, including specifically, sodium, potassium and lithium salts of ethane-1-hydroxy-1,1-diphosphonic acid; sodium, potassium and lithium salts of methylene diphosphonic acid; sodium, potassium and lithium salts of ethylene diphosphonic acid; and sodium, potassium and lithium salts of ethane-1,1,2-triphosphonic acid. Other examples include the alkali metal salts of ethane-2-carboxy-1,1-diphosphonic acid hydroxymethanediphosphonic acid, carboxyldiphosphonic acid, ethane-1-hydroxy-1,1,2-triphosphonic acid, ethane-2-hydroxy-1,1,2-triphosphonic acid, propane-1,1,3,3-tetraphosphonic acid, propane-1,1,2,3-tetraphosphonic acid, and propane-1,2,2,3-tetraphosphonic acid; (4) water-soluble salts of polycarboxylate polymers and copolymers as described in U.S. Pat. No 3,308,067.

In addition, polycarboxylate builders can be used satisfactorily, including water-soluble salts of mellitic acid, citric acid, and carboxymethyloxysuccinic acid, imino disuccinate, salts of polymers of itaconic acid and maleic acid, tartrate monosuccinate, tartrate disuccinate and mixtures thereof.

Sodium citrate is particularly preferred, to optimize the function vs. cost, (e.g. from 0 to 15%, preferably from 1 to 10%).

Certain zeolites or aluminosilicates can be used. One such aluminosilicate which is useful in the compositions of the invention is an amorphous water-insoluble hydrated compound of the formula Naₓ(_{y}AlO₂.SiO₂), wherein x is a number from 1.0 to 1.2 and y is 1, said amorphous material being further characterized by a Mg++ exchange capacity of from about 50 mg eq. CaCO₃/g. and a particle diameter of from about 0.01 micron to about 5 microns. This ion exchange builder is more fully described in British Pat. No. 1,470,250.

A second water-insoluble synthetic aluminosilicate ion exchange material useful herein is crystalline in nature and has the formula Na_{z}[(AlO₂)_{y}.(SiO₂)]xH₂O, wherein z and y are integers of at least 6; the molar ratio of z to y is in the range from 1.0 to about 0.5, and x is an integer from about 15 to about 264; said aluminosilicate ion exchange material having a particle size diameter from about 0.1 micron to about 100 microns; a calcium ion exchange capacity on an anhydrous basis of at least about 200 milligrams equivalent of CaCO₃ hardness per gram; and a calcium exchange rate on an anhydrous basis of at least about 2 grains/gallon/minute/gram. These synthetic aluminosilicates are more fully described in British Patent No. 1,429,143.

Enzymes

One or more enzymes as described in detail below, may be used in the compositions of the invention.

If a lipase is used, the lipolytic enzyme may be either a fungal lipase producible by Humicola lanuginosa and Thermomyces lanuginosus, or a bacterial lipase which show a positive immunological cross-reaction with the antibody of the lipase produced by the microorganism Chromobacter viscosum var. lipolyticum NRRL B-3673.

An example of a fungal lipase as defined above is the lipase ex Humicola lanuginosa, available from Amino under the tradename Amino CE; the lipase ex Humicola lanuginosa as described in the aforesaid European Patent Application 0,258,068 (NOVO), as well as the lipase obtained by cloning the gene from Humicola lanuginosa and expressing this gene in Aspergillus oryzae, commercially available from Novozymes under the tradename “Lipolase”. This lipolase is a preferred lipase for use in the present invention. While various specific lipase enzymes have been described above, it is to be understood that any lipase which can confer the desired lipolytic activity to the composition may be used and the invention is not intended to be limited in any way by specific choice of lipase enzyme.

The lipases of this embodiment of the invention are included in the liquid detergent composition in such an amount that the final composition has a lipolytic enzyme activity of from 100 to 0.005 LU/ml in the wash cycle, preferably 25 to 0.05 LU/ml when the formulation is dosed at a level of about 0.1-10, more preferably 0.5-7, most preferably 1-2 g/liter.

Naturally, mixtures of the above lipases can be used. The lipases can be used in their non-purified form or in a purified form, e.g. purified with the aid of well-known absorption methods, such as phenyl sepharose absorption techniques.

If a protease is used, the proteolytic enzyme can be of vegetable, animal or microorganism origin. Preferably, it is of the latter origin, which includes yeasts, fungi, molds and bacteria. Particularly preferred are bacterial subtilisin type proteases, obtained from e.g. particular strains of B. subtilis and B licheniformis. Examples of suitable commercially available proteases are Alcalase®, Savinase®, Esperase®, all of Novozymes; Maxatase® and Maxacal® of Gist-Brocades; Kazusase® of Showa Denko. The amount of proteolytic enzyme, included in the composition, ranges from 0.05-50,000 GU/mg. preferably 0.1 to 50 GU/mg, based on the final composition. Naturally, mixtures of different proteolytic enzymes may be used.

While various specific enzymes have been described above, it is to be understood that any protease which can confer the desired proteolytic activity to the composition may be used and this embodiment of the invention is not limited in any way be specific choice of proteolytic enzyme.

In addition to lipases or proteases, it is to be understood that other enzymes such as cellulases, oxidases, amylases, peroxidases and the like which are well known in the art may also be used with the composition of the invention. The enzymes may be used together with co-factors required to promote enzyme activity, i.e., they may be used in enzyme systems, if required. It should also be understood that enzymes having mutations at various positions (e.g., enzymes engineered for performance and/or stability enhancement) are also contemplated by the invention.

The enzyme stabilization system may comprise calcium ion; boric acid, propylene glycol and/or short chain carboxylic acids. The composition preferably contains from about 0.01 to about 50, preferably from about 0.1 to about 30, more preferably from about 1 to about 20 millimoles of calcium ion per liter.

When calcium ion is used, the level of calcium ion should be selected sos that there is always some minimum level available for the enzyme after allowing for complexation with builders, etc., in the composition. Any water-soluble calcium salt can be used as the source of calcium ion, including calcium chloride, calcium formate, calcium acetate and calcium propionate. A small amount of calcium ion, generally from about 0.05 to about 2.5 millimoles per liter, is often also present in the composition due to calcium in the enzyme slurry and formula water.

Another enzyme stabilizer which may be used in propionic acid or a propionic acid salt capable of forming propionic acid. When used, this stabilizer may be used in an amount from about 0.1% to about 15% by weight of the composition.

Another preferred enzyme stabilizer is polyols containing only carbon, hydrogen and oxygen atoms. They preferably contain from 2 to 6 carbon atoms and from 2 to 6 hydroxy groups. Examples include propylene glycol (especially 1,2 propane diol which is preferred), ethylene glycol, glycerol, sorbitol, mannitol and glucose. The polyol generally represents from about 0.1 to 25% by weight, preferably about 1.0% to about 15%, more preferably from about 2% to about 8% by weight of the composition.

The composition herein may also optionally contain from about 0.25% to about 5%, most preferably from about 0.5% to about 3% by weight of boric acid. The boric acid may be, but is preferably not, formed by a compound capable of forming boric acid in the composition. Boric acid is preferred, although other compounds such as boric oxide, borax and other alkali metal borates (e.g., sodium ortho-, meta- and pyroborate and sodium pentaborate) are suitable. Substituted boric acids (e.g., phenylboronic acid, butane boronic acid and a p-bromo phenylboronic acid) can also be used in place of boric acid.

One preferred stabilization system is a polyol in combination with boric acid. Preferably, the weight ratio of polyol to boric acid added is at least 1, more preferably at least about 1.3.

Another preferred stabilization system is the pH jump system such as is taught in U.S. Pat. No. 5,089,163 to Aronson et al., hereby incorporated by reference into the subject application. A pH jump heavy duty liquid is a composition containing a system of components designed to adjust the pH of the wash liquor. To achieve the required pH regimes, a pH jump system can be employed in this invention to keep the pH of the product low for enzyme stability in multiple enzyme systems (e.g., protease and lipase systems) yet allow it to become moderately high in the wash for detergency efficacy. One such system is borax 10H₂O/polyol. Borate ion and certain cis 1,2 polyols complex when concentrated to cause a reduction in pH. Upon dilution, the complex dissociates, liberating free borate to raise the pH. Examples of polyols which exhibit this complexing mechanism with borax include catechol, galacitol, fructose, sorbitol and pinacol. For economic reasons, sorbitol is the preferred polyol.

Sorbitol or equivalent component (i.e., 1,2 polyols noted above) is used in the pH jump formulation in an amount from about 1 to 25% by wt., preferably 3 to 15% by wt. of the composition.

Borate or boron compound is used in the pH jump composition in an amount from about 0.5 to 10.0% by weight of the composition, preferably 1 to 5% by weight.

Alkalinity buffers which may be added to the compositions of the invention include monoethanolamine, triethanolamine, borax and the like.

Other materials such as clays, particularly of the water-insoluble types, may be useful adjuncts in compositions of this invention. Particularly useful is bentonite. This material is primarily montmorillonite which is a hydrated aluminum silicate in which about ⅙th of the aluminum atoms may be replaced by magnesium atoms and with which varying amounts of hydrogen, sodium, potassium, calcium, etc. may be loosely combined. The bentonite in its more purified form (i.e. free from any grit, sand, etc.) suitable for detergents contains at least 50% montmorillonite and thus its cation exchange capacity is at least about 50 to 75 meq per 100 g of bentonite. Particularly preferred bentonites are the Wyoming or Western U.S. bentonites which have been sold as Thixo-jels 1, 2, 3 and 4 by Georgia Kaolin Co. These bentonites are known to soften textiles as described in British Patent No. 401, 413 to Marriott and British Patent No. 461,221 to Marriott and Guam.

In addition, various other detergent additives or adjuvants may be present in the detergent product to give it additional desired properties, either of functional or aesthetic nature.

Improvements in the physical stability and anti-settling properties of the composition may be achieved by the addition of a small effective amount of an aluminum salt of a higher fatty acid, e.g., aluminum stearate, to the composition. The aluminum stearate stabilizing agent can be added in an amount of 0 to 3%, preferably 0.1 to 2.0% and more preferably 0.5 to 1.5%.

There also may be included in the formulation, minor amounts of additional soil suspending or anti-redeposition agents, e.g. polyvinyl alcohol, fatty amides, sodium carboxymethyl cellulose, hydroxy-propyl methyl cellulose. A preferred anti-redeposition agent is sodium carboxylmethyl cellulose having a 2:1 ratio of CM/MC which is sold under the tradename Relatin DM 4050.

Optical brighteners for cotton, polyamide and polyester fabrics can be used. Suitable optical brighteners include Tinopal® LMS-X, Tinopal® CBS-X, stilbene, triazole and benzidine sulfone compositions, especially sulfonated substituted triazinyl stilbene, sulfonated naphthotriazole stilbene, benzidene sulfone, etc. Most preferred are UV/stable brighteners (for compositions visible in transparent containers), such as distyrylbiphenyl derivatives (Tinopal® CBS-X).

Anti-foam agents, e.g. silicon compounds, such as Silicane® L 7604,can also be added in small effective amounts.

Bactericides, e.g. tetrachlorosalicylanilide and hexachlorophene, fungicides, dyes, pigments (water dispersible), preservatives, e.g. formalin, ultraviolet absorbers, anti-yellowing agents, such as sodium carboxymethyl cellulose, pH modifiers and pH buffers, color safe bleaches, perfume and dyes and bluing agents such as Iragon Blue L2D, Detergent Blue 472/572 and ultramarine blue can be used.

Also, additional soil release polymers and cationic softening agents may be used.

Preferably, the detergent composition is a colored composition packaged in the transparent/translucent (“see-through”) container.

Container

Preferred containers are transparent/translucent bottles. “Transparent” as used herein includes both transparent and translucent and means that a composition, or a package according to the invention preferably has a transmittance of more than 25%, more preferably more than 30%, most preferably more than 40%, optimally more than 50% in the visible part of the spectrum (approx. 410-800 nm). Alternatively, absorbency may be measured as less than 0.6 (approximately equivalent to 25% transmitting) or by having transmittance greater than 25% wherein % transmittance equals: 1/10^{absorbancy}×100%. For purposes of the invention, as long as one wavelength in the visible light range has greater than 25% transmittance, it is considered to be transparent/translucent.

Transparent bottle materials with which this invention may be used include, but are not limited to: polypropylene (PP), polyethylene (PE), polycarbonate (PC), polyamides (PA) and/or polyethylene terephthalate (PETE), polyvinylchloride (PVC); and polystyrene (PS). The preferred inventive compositions which are packaged into transparent containers include an opacifier to impart a pleasing appearance to the product. The inclusion of the opacifier is particularly beneficial when the liquid detergent compositions in the transparent containers are in colored. The preferred opacifier is styrene/acrylic co-polymer. The opacifier is employed in amount of from 0.0001 to 1%, preferably from 0.0001 to 0.2%, most preferably from 0.0001 to 0.04%.

The container of the present invention may be of any form or size suitable for storing and packaging liquids for household use. For example, the container may have any size but usually the container will have a maximal capacity of 0.05 to 15 L, preferably, 0.1 to 5 L, more preferably from 0.2 to 2.5 L. Preferably, the container is suitable for easy handling. For example the container may have handle or a part with such dimensions to allow easy lifting or carrying the container with one hand. The container preferably has a means suitable for pouring the liquid detergent composition and means for reclosing the container. The pouring means may be of any size of form but, preferably will be wide enough for convenient dosing the liquid detergent composition. The closing means may be of any form or size but usually will be screwed or clicked on the container to close the container. The closing means may be cap which can be detached from the container. Alternatively, the cap can still be attached to the container, whether the container is open or closed. The closing means may also be incorporated in the container.

The following specific examples further illustrate the invention, but the invention is not limited thereto. The suppliers and tradenames used for the Examples were as follows:

| Chemical, Function | Trade Name | Supplier |
|---|---|---|
| monoethanolamine | | Dow |
| sodium citrate | | ADM |
| coconut oil fatty acid | TRC-103 | Twin Rivers |
| preservative | Kathon ® CG/ICPII | Rohm and |
| | | Haas |
| sodium linear alkylbenzene | Biosoft ® 5100 | Sasol or Stepan |
| sulfonate | | |
| alcohol ethoxylate, 9EO | Suffonic ® L24-9 | Huntsman |
| sodium alcohol ethoxy sulfate | BSST1TC | Stepan |
| propylene glycol | | Dow |
| distyrylbiphenyl fluorescer | Tinopal ® CBS-XSP | Ciba |
| polyvinyl pyrrolidone | PVP K15 | ISP |
| sorbitol | | ADM |
| borax | | US Borax |
| soil release co-polymer, acrylic | Alcosperse ® 725 | Alco |
| acid/styrene | | |
| soil release co-polymer, acrylic | Narlex ® DC-1 | Alco |
| acid/laurylmethacrylate | | |
| proteolytic enzyme | Savinase ® 16 L Type | Novozymes |
| | EX | |
| lipolytic enzyme | Lipex ® | Novozymes |

The following test protocol was used for measuring absolute anti-redeposition efficacy:

| Products: | Experimental Products Evaluated at Equal Weight Dosage | |
|---|---|---|
| Fabric Substrates: | Anti-Redeposition Fabrics: Clean (no soiling) monitor fabrics of | |
| | several different fabric compositions are added into the wash along | |
| | with soiled stain fabrics that serve as the source of soiling in the | |
| | wash. The clean monitors are used to measure the efficacy of the | |
| | products for preventing soil redeposition. | |
| Stained fabrics | Baseball field dirt on polyester fabric and Georgia Clay on | |
| (source of soiling): | nylon/lycra fabric | |
| Test Replication: | Four replicates in total. Two replicate monitors per each fabric type | |
| | are used in each of two replicate washes. The test is replicated in two | |
| | separate/independent wash test runs. | |
| Wash load: | The wash load includes the stained fabrics serving as the source of | |
| | soiling, the clean monitor fabrics measuring anti-redeposition and | |
| | standard ballast fabrics to total approximately 2 kg. | |
| Washer/Dryer | Testing is conducted in the same two washers for the two replicate | |
| | wash runs. Washers are rotated between the two products for the two | |
| | replicate runs. Drying of corresponding fabrics for both products are | |
| | dried in the same dryer using the dryer rack. | |
| Wash: | washer | Sears Kenmore ® |
| | wash cycle | Heavy Duty/fast/fast |
| | water volume | 6.43 liters |
| | temperature | warm, 32° C. |
| | hardness | ˜120 ppm, Edgewater water |
| | wash time | 12 minutes |
| Rinse: | number of rinses | one |
| | temperature | cold, 21° C. |
| Drying: | automatic dryer | Sears Kenmore ® Dryer |
| | drying cycle | Normal, Permanent Press, Medium High |
| Heat | drying time | 45 mins |

| | |
|---|---|
| Anti-redeposition | Anti-redeposition efficacy is expressed in terms of the whiteness |
| Assessment: | values of the fabrics before and after washing. Whiteness is |
| | determined from instrumental values measured as follows. |
| | Reflectance measurements are taken on the unwashed and washed |
| | fabrics using a Hunter Spectrophotometer (Sphere Geometry ) using |
| | the following settings: 420nm Filter In, Specular Included, D65, |
| | 10 degree observer, CIELab, with 4 layers of fabric swatches. Anti- |
| | redeposition is evaluated using the following Delta Whiteness |
| | (D_White) function: |
| | D_White = (L_{c} − 3b_{c}) − (L_{w} − 3b_{w}) |

| | |
|---|---|
| Where, | L-Lightness |

b-yellowness/blueness
c-clean unwashed white fabric
w-washed fabric

| | |
|---|---|
| Statistical Analysis: | Analysis of Variance is used to establish the statistical value of the |
| | data at 95% confidence level. |

### EXAMPLES 1-2

### Comparative Examples A-B

The following compositions were prepared: examples 1 and 2 were within the scope of the invention, examples A and B were comparative examples and outside the scope of the invention. The Control composition was also outside the scope of the invention and was used as a benchmark to measure the performance of the rest of the compositions in this experiment.

| | | Example | | | |
|---|---|---|---|---|---|
| Chemical, Function | Control | A | B | 1 | 2 |
| | | weight % in formula | | | |
| monoethanolamine | 0.23 | 0.45 | 0.45 | 0.45 | 0.45 |
| sodium citrate | 3.20 | 7.00 | 5.00 | 5.00 | 5.00 |
| coconut oil fatty acid | 0.77 | 1.55 | 1.55 | 1.55 | 1.55 |
| preservative | 0.00075 | 0.00075 | 0.00075 | 0.00075 | 0.00075 |
| sodium linear alkylbenzene | 6.00 | 5.10 | 5.10 | 5.10 | 5.10 |
| sulfonate | | | | | |
| alcohol ethoxylate, 9EO | 6.60 | 5.60 | 5.60 | 5.60 | 5.60 |
| sodium alcohol ethoxy sulfate | 10.50 | 8.90 | 8.90 | 8.90 | 8.90 |
| propylene glycol | 4.75 | 4.40 | 4.40 | 4.40 | 4.40 |
| distyrylbiphenyl fluorescer | 0.125 | 0.10 | 0.10 | 0.10 | 0.10 |
| polyvinylpyrrolidone | 0.00 | 0.25 | 0.25 | 0.25 | |
| sorbitol | 3.35 | 3.35 | 3.35 | 3.35 | 3.35 |
| borax | 2.30 | 2.30 | 2.30 | 2.30 | 2.30 |
| soil release co-polymer, | 0.30 | 0.33 | 0.00 | 0.12 | 0.25 |
| acrylic acid/styrene | | | | | |
| proteolytic enzyme | 0.80 | 0.76 | 0.76 | 0.76 | 0.76 |
| lipolytic enzyme | 0.25 | | | | |

The anti-redeposition properties of all the compositions were measured, using the protocol as described above. The results that were obtained are summarized in Table 1 as follows:

TABLE 1

| | ANTI-REDEPOSITION | | | | | | | | | | | |
|---|---|---|---|---|---|---|---|---|---|---|---|---|
| | | | | | | | 50/50 | | | | | |
| | Cotton | | 100% Cotton | | Knit | | Polyester/ | | Knit 50:50 | | 100% Nylon | |
| | Woven | | Knit | | Polyester | | Cotton Woven | | Blend | | Woven | |
| Example | DW* | Delta** | DW* | Delta** | DW* | Delta** | DW* | Delta** | DW* | Delta** | DW* | Delta** |
| Control | C | — | B | — | C | | D | — | B | — | B | — |
| A | C | −0.10⁰ | B | 0.48⁰ | A | 0.39² | DE | −1.13⁰ | AB | 0.73⁰ | C | −1.13¹ |
| B | E | −9.01¹ | D | −6.16¹ | C | −0.01⁰ | E | −1.39¹ | C | −1.71¹ | D | −2.62¹ |
| 1 | B | 1.40² | A | 2.11² | A | 0.37² | B | 12.31² | AB | 0.72² | B | 0.28⁰ |
| 2 | A | 1.83² | A | 2.36² | A | 0.37² | A | 13.99² | A | 1.92² | A | 0.78² |

DW = D_White of Final Fabric-D_White of Initial Fabric (see Protocol)
DW* = Statistical Significance at 95% CL of DW
Designation using same letters, e.g., “A” and “A”, denotes statistical equality at 95% confidence level. Designation using two different letters, e.g. “A” and “B”, means products are significantly different at 95% confidence level
Delta** = DW Experimental Product − DW Control Product
²Statistical Win For Experimental Product Relative To Control Product
¹Statistical Loss For Experimental Product Relative To Control Product
⁰Equality/No Difference For Experimental Product Relative To Control Product

It can be seen from the results in Table 1, that on 4 out of 6 types of fabrics, Examples 1 and 2 within the scope of the invention, employing a combination of soil release co-polymer and anti-redeposition enhancer ingredients according to the invention, exhibited synergistic improvement in soil anti-redeposition compared to either Examples A or B which contained only one of the ingredients.

### EXAMPLE 3

### Comparative Example C

The following isotropic liquid detergent compositions were prepared. Example 3 was within the scope of invention. Example C lacked an anti-redeposition enhancer and, thus, was outside the scope of the invention. The Control used in this experiment was Comparative Example B (also outside the scope of the invention).

| | |
|---|---|
| Example 3 | Example C |

| | |
|---|---|
| Chemical, Function | % in formulation |

| | | |
|---|---|---|
| Monoethanolamine | 0.45 | 0.45 |
| sodium citrate | 5.00 | 5.00 |
| coconut oil fatty acid | 1.55 | 1.55 |
| Preservative | 0.00075 | 0.00075 |
| sodium linear alkylbenzene sulfonate | 5.10 | 5.10 |
| alcohol ethoxylate, 9EO | 5.60 | 5.60 |
| sodium alcohol ethoxy sulfate | 8.90 | 8.90 |
| propylene glycol | 4.40 | 4.40 |
| distyrylbiphenyl fluorescer | 0.10 | 0.10 |
| Polyvinylpyrrolidone | 0.25 | 0.00 |
| Sorbitol | 3.35 | 3.35 |
| Borax | 2.30 | 2.30 |
| soil release co-polymer, acrylic | 1.00 | 1.00 |
| acid/laurylmethacrylate | | |
| proteolytic enzyme | 0.76 | 0.76 |

The anti-redeposition performance of these compositions was measured. The results that were obtained are summarized in Table 2.

TABLE 2

| | ANTI-REDEPOSITION EFFICACY | | | | | | | | | | | |
|---|---|---|---|---|---|---|---|---|---|---|---|---|
| | | | | | | | 50/50 | | | | | |
| | 100% | | | | | | Polyster | | | | | |
| | Cotton | | 100% Cotton | | Knit | | Cotton | | Knit 50:50 | | 100% Nylon | |
| | Woven | | Knit | | Polyester | | Woven | | Blend | | Woven | |
| Composition | DW* | Delta** | DW* | Delta** | W* | Delta** | DW* | Delta** | DW* | Delta** | DW* | Delta** |
| Control | C | — | B | — | B | — | B | — | C | — | B | — |
| Example C | B | 7.01¹ | A | 8.18¹ | A | 0.26¹ | C | −4.58² | B | 1.63¹ | A | 4.21¹ |
| Example 3 | A | 8.67¹ | A | 8.51¹ | A | 0.32¹ | A | 16.17¹ | A | 2.82¹ | A | 4.43¹ |

DW = D_White of Final Fabric-D_White of Initial Fabric (see Protocol)
DW* = Statistical Significance at 95% CL of DW
Designation using same letters, e.g., “A” and “A”, denotes statistical equality at 95% confidence level. Designation using two different letters, e.g. “A” and “B”, means products are significantly different at 95% confidence level
Delta** = DW Experimental Product − DW Control Product
²Statistical Win For Experimental Product Relative To Control Product
¹Statistical Loss For Experimental Product Relative To Control Product
⁰Equality/No Difference For Experimental Product Relative To Control Product

It can be seen from the results in Table 2, that Example 3 within the scope of the invention, employing a combination of soil release co-polymer and anti-redeposition enhancer according to the invention, was superior to comparative Example C, on 3 out of 6 fabric types.

### EXAMPLES 4-5

The following compositions within the scope of the invention comprising a synergistic mixture of soil release co-polymer and anti-redeposition enhancer were prepared. The compositions were colored and were placed in a transparent plastic container. The compositions were isotropic in nature (no phase separation was observed) and were aesthetically pleasing in appearance.

| | |
|---|---|
| Example 4 | Example 5 |

| | |
|---|---|
| Chemical, Function | Weight % |

| | | |
|---|---|---|
| Monoethanolamine | 0.45 | 0.45 |
| sodium citrate | 5.00 | 5.00 |
| coconut oil fatty acid | 1.55 | 1.55 |
| preservative | 0.00075 | 0.00075 |
| sodium linear alkylbenzene | 5.10 | 5.10 |
| sulfonate | | |
| alcohol ethoxylate, 9EO | 5.60 | 5.60 |
| sodium LES | 8.90 | 8.90 |
| colorant | 0.002 | |
| FD&C | | 0.0005 |
| opacifier, styrene/acrylic | 0.012 | 0.012 |
| perfume | 0.25-0.29 | 0.25-0.29 |
| propylene glycol | 4.40 | 4.40 |
| whitener Tinopal CBS-XSP | 0.10 | 0.10 |
| polyvinyl pyrrolidone | 0.25 | 0.25 |
| sorbitol | 3.35 | 3.35 |
| borax | 2.30 | 2.30 |
| soil release co-polymer acrylic | 0.12 | 0.12 |
| acid/styrene | | |
| proteolytic enzyme | 0.43 | 0.43 |

What is claimed is:

1. An isotropic liquid detergent composition comprising:
(a) from about 0.01% to about 10%, by weight of the composition, of an soil release co-polymer having a hydrophilic backbone comprising hydrophilic monomer units and a hydrophobic tail comprising hydrophobic monomer units,
(b) from about 0.01 to about 5%, by weight of the composition, of an anti-redeposition enhancer selected from the group consisting of vinyl pyrrolidone polymer, vinyl-pyridine N-oxide polymer, and mixtures thereof, and
(c) a surfactant.

2. The composition according to claim 1 wherein the surfactant is a mixture of anionic and nonionic surfactants.

3. The composition according to claim 1, wherein the surfactant is a mixture of linear alkyl aryl sulfonates (LAS), alcohol ethoxy alkoxylate sulfates (AES) and alkoxylated nonionics.

4. The composition according to claim 2, wherein the weight ratio of the anionic surfactant to the nonionic surfactant is about 5:1 and below.

5. The composition according to claim 1 further comprising from about 1% to about 15%, by weight of the composition, of a hydrotrope.

6. The composition according to claim 1, wherein the hydrotrope is polyol.

7. The composition according to claim 1, wherein the soil release co-polymer has the following formula: 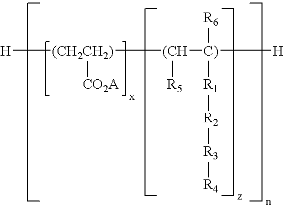
wherein
z is at least 1;
x:z is less than 60,
in which the monomer units may be in random order; and
n is at least 1:
R₁ represents —CO—O—, —O—, —O—CO—, —CH₂—, —CO—NH— or is absent;
R₂ represents from 1 to 50 independently selected alkyleneoxy groups preferably ethylene oxide or propylene oxide groups, or is absent, provided that when R₃ is absent and R₄ represents hydrogen or contains no more than 4 carbon atoms, then R₂ must contain an alkyleneoxy group with at least 3 carbon atoms;
R₃ represents a phenylene linkage, or is absent;
R₄ represents hydrogen or a C₁₋₂₄ alkyl or C₂₋₂₄ alkenyl group, with the provisos
a) when R₁ represents —O—CO—, R₂ and R₃ must be absent and R₄ must contain at least 5 carbon atoms;
b) when R₂ is absent, R₄ is not hydrogen and when R₃ is absent, then R₄ must contain at least 5 carbon atoms;
R₅ represents hydrogen or a group of formula —COOA;
R₆ represents hydrogen or C₁₋₄ alkyl; and A is independently selected from hydrogen, alkali metals, alkaline earth metals, ammonium and amine bases and C₁₋₄.

8. The composition according to claim 7, wherein the R₂ alkyleneoxy groups are ethylene oxide or propylene oxide groups.

9. The composition according to claim 1 wherein the backbone monomer unit is acrylate and the tail comprising hydrophobic monomer unit is alkyl methacrylate.

10. The composition according to claim 1, wherein the backbone monomer unit is acrylate and the tail comprising hydrophobic monomer unit is styrene.

11. The composition according to claim 1, wherein the composition is in a transparent/translucent container.

12. The composition according to claim 11, wherein the composition further comprises an opacifier.

13. The composition according to claim 12, wherein the composition is colored.

14. The composition according to claim 11, wherein the composition further comprises a UV-stable brightener.
